(19) United States
(12) Patent Application Publication
(10) Pub. No.: US 2025/0362191 A1
(43) Pub. Date: Nov. 27, 2025

(54) Structural Element, Sensor System and Method for Monitoring a Through-Opening

(71) Applicant: Hilti Aktiengesellschaft, Schaan (LI)

(72) Inventors: Michal Wladyslaw ZIENTEK, Nenzing (AT); Simon ROLSHOVEN, Feldkirch (AT)

(21) Appl. No.: 18/874,855

(22) PCT Filed: May 31, 2023
(86) PCT No.: PCT/EP2023/064467

§ 371 Date: Dec. 13, 2024

(30) Foreign Application Priority Data
Jun. 14, 2022 (EP) 22178808.6

(51) Int. Cl. G01L 1/24; G01L 1/22

(52) U.S. Cl. CPC G01L 1/242; G01L 1/2262

(57) ABSTRACT

A structural element having a through-opening includes a sensor system for monitoring the through-opening. The sensor system has at least one sensor for detecting a measured value of the through-opening. The at least one sensor is disposed on an inner perimeter of the through-opening. A secure monitoring of the through-opening is provided while still allowing changes to be made in the interior of the through-opening.

### BACKGROUND AND SUMMARY OF THE INVENTION

The invention relates to a structural element, for example, a wall, a ceiling or floor of a building, having a through-opening. The structural element should be protected against the spread of hazards such as heat or cold, smoke, noise or the like through the through-opening.

The through-opening can be used for the passage of conduits such as power cables or water pipes.

The rest of the through-opening can be filled with filling elements, such as fire-resistant bricks.

For safety reasons, such protected through-openings must be checked regularly.

Until now, this check has usually been completed by manual visual inspection. This is very time-consuming. In addition, due to excessively long inspection intervals, longer periods of time may occur during which the proper functioning of such protection cannot be ensured.

As an alternative, individual cases of sensor systems are also known, which automatically perform such a check of the through-opening. Such systems must be installed, for example, in front of or behind the through-opening. Therefore, if new conduits need to be routed through the through-opening or if existing conduits need to be removed from the through-opening, these sensor systems must be removed first. Depending on the mounting of the sensor systems, this can be very time-consuming. It is also often not possible to remove the sensor system without damaging at least one part.

This will result in significant additional costs for such retrospective modifications.

The same applies to the monitoring of other through-openings, for example, with filling elements which are used to protect against the spread of noise or similar hazards.

The object of the present invention is therefore to provide a structural element, a sensor system, and a method that allow a simple inspection of a through-opening, wherein it is particularly desirable that subsequent modifications to the through-opening can be easily carried out.

The object is achieved by a structural element with a through-opening, comprising a sensor system, wherein the sensor system is designed for monitoring the through-opening, wherein the sensor system has at least one sensor for detecting a measured value of the through-opening, and the sensor is arranged on an inner perimeter of the through-opening.

The structural element can be, for example, a wall, a ceiling or a floor of a building. The component may be relevant to structural and/or civil engineering work.

The sensor can thus be located inside the through-opening. In particular, it cannot sit on the outside of the structural element or on elements located in the through-opening. Seated on the inner perimeter of the through-opening, the sensor does not interfere with filling the through-opening even in the case of retrospective changes. This allows unhindered access to the through-opening. Changes in the region of the through-opening are not hindered by the sensor system.

The sensor may be configured to directly or indirectly monitor at least one region of the interior of the through-opening from the inner perimeter.

If modifications are made in the interior of the through-opening, this leads to vibrations, changes in forces and pressures, for example clamping, compressive, bending forces, or similar physical effects.

Thus, a change in the interior can be detected by the sensor or sensors, by the sensor detecting one or more of these physical effects.

Thus, even retrospective changes to the filling of the through-opening, or to the condition of the through-opening in general, can be detected, although the sensors are arranged only on one edge of the through-opening, in particular on the inner perimeter of the through-opening.

“Monitoring” can mean that at least one measured value is acquired. “Monitoring” can also include identifying changes in the measured value and/or identifying that the measured value departs from an associated target value range. “Monitoring” can also include an action being triggered whenever such an event occurs, e.g., a change and/or a departure from the target value range. The action may include, for example, a documentation action and/or triggering an alarm signal.

In particular, “monitoring” of the through-opening can be understood to mean detecting a change to filling elements located in the through-opening. In particular, “monitoring” may include detecting when a filling element located in the through-opening is added, removed or changed, for example, deformed and/or changed in its position and/or location. Such filling elements can be, for example, fireproof elements.

Thus, such a monitoring can ensure that in the case of a through-opening, for example a through-opening in a partition wall between two rooms, with the through-opening sealed with fireproof elements apart from any pipes or cables passing through it, uninterrupted fireproofing can be ensured. In particular, the monitoring can ensure that none of the fireproofing elements will slip, fall out or the like.

Generally, the sensor system can be configured to acquire measured values on the inner perimeter of the through-opening in at least two opposite regions of the through-opening.

It is conceivable for the same sensor to extend over two opposite regions.

Alternatively or in addition, the sensor system can also comprise a plurality of sensors. At least one of the sensors can then be located in one of the at least two opposing regions. Particularly preferably, the sensor system is designed to monitor at least two pairs of each opposite pair of regions, i.e., a total of at least four regions.

The sensor can extend over at least two opposite regions of the through-opening.

This is based on the idea that the physical effects mentioned above often produce a directed action and can thus exert opposing actions on two of the opposite regions. Thus, changes in the through-opening can be detected with even greater sensitivity. In addition, additional information can be obtained about the changes taking place in the through-opening.

The through-opening can be filled with at least one filling element. In particular, at least one cross-sectional area of the through-opening, optionally with the exception of conduit cross-sections extending through the through-opening, may be filled with filling elements.

The filling element can be elastically deformable. The at least one cross-sectional area can then be easily sealed with the filling elements by inserting the filling elements into the cross-sectional area under pressure. Elastic filling elements can also be used to ensure a particularly secure sealing of the through-opening.

It is conceivable that the filling element has at least one protective function. The filling element can be, for example, fire-retardant, heat-insulating, sound-insulating and/or fluid-sealing. Smoke, heat and/or the like can thus only pass through the through-opening to a reduced extent, or even not at all. Such a protective function of the filling element can be considered to be present, in particular, if the filling element meets a corresponding minimum requirement of a relevant performance standard, for example a relevant fire safety standard.

By means of the sensor system, it can be particularly effectively ensured that a through-opening filled with such filling elements offers long-term protection corresponding to the protective function of the filling elements. In particular, the through-opening can be monitored with regard to unwanted changes, for example filling elements that have fallen out of the through-opening due to external effects, incorrectly arranged filling elements or the like.

The invention further relates to a sensor system for a structural element, wherein the structural element is designed as described above and/or below, the sensor system comprising: at least one sensor that can be arranged on an inner perimeter of the through-opening of the structural element, the sensor being configured to detect a measured value of the through-opening.

Changes in the through-opening can be easily detected without the sensor needing to have direct access to the changing region within the through-opening via sensors, if the sensor is a pressure, stress, strain and/or force sensor.

The corresponding forces or pressures can propagate from one filling element to another filling element. Thus, changes in the corresponding physical effects can also be detected from the inner perimeter, even if changes take place in the interior of the through-opening and remotely from the sensor, in particular in a space not directly adjacent to the sensor.

The sensor can have an elongated shape. For example, the sensor may be strip-shaped.

In particular, it is conceivable that the sensor comprises a strain gauge and/or a pressure-sensitive material.

The sensor may comprise a layer structure. A layer can be a protective layer. The protective layer can be designed, for example, to protect against mechanical damage, such as scratch marks or the like. One layer can be a sensor layer. The sensor layer can be designed to capture the physical effect intended for detection. The sensor layer can be particularly sensitive to pressure, tension and/or bending.

The sensor can be attached to the inner perimeter of the through-opening particularly simply if it has at least one adhesive layer and/or a friction-enhancing layer. The through-opening can also be filled with filling elements and/or conduits without having to hold the sensor in place. The action of the adhesive layer and/or the friction-enhancing layer can be based on adhesion. The adhesive layer and/or the friction-enhancing layer may be formed from a rubber-like material and/or from a silicone-containing material or at least comprise such a material.

The sensor can comprise at least one optical fiber. The advantage of optical fibers is that they also enable forces or pressures acting on the sensor to be detected at a large number of locations simultaneously. This can facilitate the evaluation of signals from the sensor considerably. The use of optical fibers can also allow a spatially resolved measurement of the respective physical effect along the course of the optical fiber.

The sensor system can comprise at least two, preferably at least four, sensors. If it contains four sensors, for example, they can be arranged in pairs on a total of four opposite sides of the through-opening. Thus, for example, shear forces can be detected in the direction of the sensors arranged opposite each other in pairs.

It is also conceivable that at least two, preferably all, of the sensors are connected in series. Thus, the number of cables required from and/or to the sensors can be significantly reduced. Cable tangles can be avoided. The installation of the sensor system can thus be considerably simplified and speeded up.

Our own tests have shown that the measurement results of the sensors can be highly temperature dependent. In order to avoid false alarms due to such a temperature dependence and in particular to reduce the temperature dependence of the measurement results of the sensors, a plurality of sensors, in particular at least four sensors, may be arranged in a Wheatstone bridge.

The sensor system may comprise a power source for supplying power. For example, the power source may comprise a rechargeable accumulator. In particular, it is conceivable that the power source can be recharged wirelessly, for example inductively.

Also, the sensor system can comprise a controller. The controller can comprise a microcontroller. The microcontroller may be configured to monitor the through-opening by means of the sensor of the sensor system.

The controller and/or the power source can be installed in a housing. They can thus be protected from environmental influences. The sensor system can therefore have a particularly long service life.

In particularly advantageous embodiments, the sensor system, in particular the controller, can comprise a communication module. The communication module can be and/or comprise a wireless communication module. In particular, it is conceivable that the communication module complies with a radio standard which is particularly suitable for communicating from out of a structural element, for example from the inside of a reinforced concrete wall. Preferably, the radio standard used by the communication module is also configured for particularly energy-conserving operation.

It is then possible for the sensor system to transmit captured measured values and/or detected changes in and/or on the through-opening to a remote computer system. The remote computer system can be a cloud-based computing system. In particular, it is conceivable that the cloud-based computer system and/or another computer system, separate from the cloud-based computer system, is configured to query a status of the sensor system and/or of a through-opening assigned to the sensor system. For example, a status of the sensor system can correspond to a state of charge of the energy storage device. A status of the through-opening can correspond, for example, to a correct or incorrect arrangement of the filling elements in the through-opening.

For example, it is conceivable that a user of the other computer system retrieves the status from a distance via the cloud-based computer system. The user can thus determine quickly and easily whether, for example, the through-opening is still correctly filled or whether, for example, the through-opening has impermissible gaps due to improper filling with filling elements.

The invention also relates to a filling element with a sensor system according to the type described above and/or below.

At least one sensor of the sensor system can be arranged on a perimeter of the filling element. Preferably, all sensors can be arranged on the perimeter of the filling element.

If the filling element is brought into the through-opening, at least one sensor of the sensor system can therefore be arranged on the inner perimeter of the through-opening.

For this purpose, the filling element can have dimensions corresponding to or at least substantially corresponding to the internal dimensions of the through-opening on which the filling element is to be arranged. In this case, “substantially corresponding to” can be understood, for example, in the case of a compressible filling element, that while it may be larger than the through-opening in one dimension, it can at least be fitted into the through-opening under pressure.

The sensor or sensors can be arranged on the outer perimeter of the filling element. It is conceivable, alternatively or in addition, that the sensor or sensors is or are arranged on the inner perimeter of the filling element.

Thus, a through-opening can easily be equipped with a sensor system, even retrospectively, wherein the through-opening can also be filled with a filling element.

The filling element can be formed as a polyhedron, for example as a cuboid. It can be stackable in a closely spaced manner.

Particularly preferably, the filling element can be a fire-resistant brick and/or comprise such a brick. The through-opening can therefore be sealed in a fireproof or at least fire-retardant manner.

Thus, a structural element of the type described above and/or hereafter can be subsequently generated from a structural element with a through-opening, in which the filling element together with the sensor system is fitted into the through-opening.

Depending on the type and/or size of the filling element, it is conceivable to insert one or more such filling elements into the through-opening to fill the through-opening completely.

It may be provided that at least two of the filling elements are connected to a common controller and/or a common power source. For this purpose, the filling element may comprise a detachable cable connector, for example a plug contact. A supply cable of the power source can be plugged into the detachable cable connector.

In this case it is conceivable, alternatively or in addition, that the controller and/or the power source is or are arranged in the interior of the filling element, so that a particularly compact shape and thus a simplified installation results.

The invention further relates to a method for monitoring a structural element, wherein the structural element corresponds to a structural element as described above and/or below. According to the method, a measured value of the through-opening of the structural element is measured by a sensor located on an inner perimeter of the through-opening.

Two measured values can be measured on at least two opposite regions of the inner perimeter of the through-opening.

In particular, it is conceivable that a differential signal is formed from measured values of sensors located opposite each other in pairs. This allows further details about changes in a through-opening to be determined. For example, a direction of a force acting on filling elements of the through-opening can be determined. This also allows further details about the type of change to be determined, such as whether a new filling element has been added, an existing filling element has been removed, and/or a filling element has been moved.

Further features and advantages of the invention are apparent from the detailed description of exemplary embodiments of the invention that follows, with reference to the figures which show details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawings and elucidated in detail in the description that follows.

### BRIEF DESCRIPTION OF THE DRAWINGS

FIG. 1 shows a structural element having a through-opening and a sensor system;

FIG. 2 shows the structural element according to FIG. 1, which is connected via a cloud-based computer system to a user computer system;

FIG. 3 shows a flowchart of a method for monitoring a through-opening;

FIG. 4 shows a filling element;

FIG. 5 shows a structural element having the filling element as shown in FIG. 4; and

FIG. 6 shows a circuit diagram with four sensors interconnected in a Wheatstone bridge.

### DETAILED DESCRIPTION OF THE DRAWINGS

In the description of the figures that follows, comprehension of the invention is facilitated by use of the same reference signs in each case for identical or functionally corresponding elements.

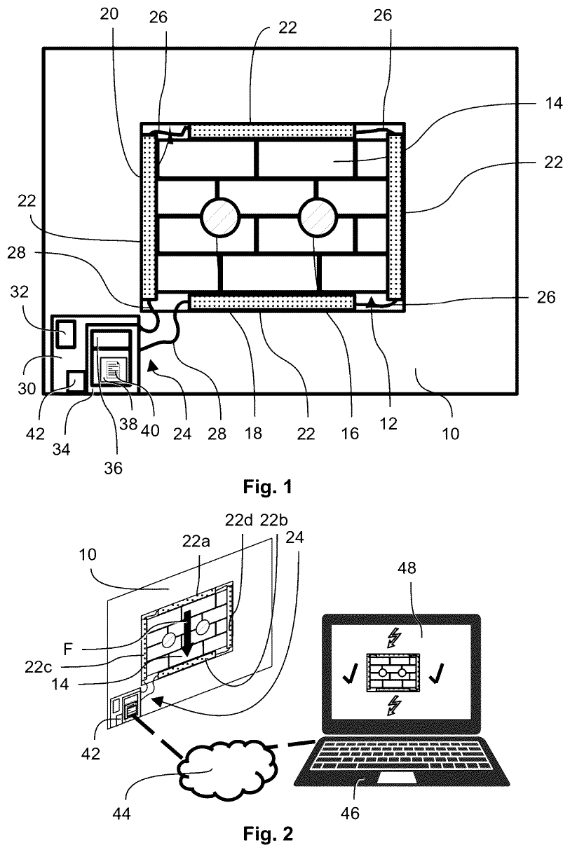

FIG. 1 shows a structural element 10 having a through-opening 12 in a schematic view from the front.

The through-opening 12 is filled with filler elements 14. For reasons of clarity, in FIG. 1 only one of the filling elements is provided with a reference sign as an example.

Conduits 16, 18 run between the individual filling elements 14, i.e., the fire-resistant bricks.

The filling elements 14 are fire-resistant bricks. They are elastically deformable. The filling elements 14 seal the interior of the through-opening 12. Thus, the through-opening 12 is designed to be fire-retardant.

Four sensors 22 of a sensor system 24 are located on an inner perimeter 20 of the through-opening 12. The four sensors 22 are each arranged in pairs in regions of the inner perimeter 20 located opposite each other. Thus, two of the four sensors 22 are located opposite each other.

The sensors 22 are interconnected via electrical connecting leads 26. The sensors 22 are electrically connected in series. A beginning of this series and an end of this series is connected to a controller 30 of the sensor system 24 by connecting cables 28.

The sensors 22 are pressure sensors. In particular, they are designed to measure compressive forces acting on them transversely to their length. They can comprise at least one optical fiber for this purpose. Alternatively or additionally, they can also comprise at least one strain gauge.

The controller 30 comprises a power source 32. The power source 32 is designed to supply the sensor system 24, in particular the sensors 22 and the controller 28, with electrical power. The power source 32 comprises a rechargeable accumulator. For example, this can be a lithium-based rechargeable battery.

The controller 30 also has a microcontroller 34. The microcontroller 34 comprises a processor 36, memory 38, and program code 40. The program code 40 is stored retrievably in the memory 38 and can be executed on the processor 36.

The program code 40 in conjunction with the rest of the microcontroller 34 is designed to evaluate measured values received from the sensors 22. In particular, it is designed to detect changes within the through-opening 12 from changes in the measured values of the sensors 22.

For this purpose, the program code 40 in conjunction with the processor 36 and the memory 38 is designed to form two pairs of differential signals from two pairs of opposite sensors 22 from the measured values of the four sensors 22.

The controller 30 also comprises a communication module 42. The communication module 42 comprises a radio module for wireless communication with an external computer system.

FIG. 2 shows a schematic, perspective representation of the structural element 10 from FIG. 1 as well as a cloud-based computer system 44 and a user computer system 46 of a user of the structural element 10 and its sensor system 24.

In the schematic representation according to FIG. 2, it can be seen that the communication module 42 is designed to transfer data of the sensor system 24 to the cloud-based computer system 44.

From the cloud-based computer system 44, data can be retrieved in whole or in part from the user computer system 46, further evaluated and/or made available to the user.

As an example, in FIG. 2 a black arrow pointing downwards schematically illustrates that a compressive force F directed downwards acts on the filling elements 14 in the through-opening 12.

The compressive force F thus relieves the load on an upper sensor 22a, whereas a sensor 22b arranged below it is under additional load. A pressure difference between these two sensors 22a, 22b can thus be recorded.

However, two laterally arranged sensors 22c, 22d remain at least largely unaffected by the compressive force F. Thus, no pressure difference is detected between these sensors 22c, 22d.

Due to the detectable pressure difference, a display 48 of the user computer system 46 outputs a negative signal with respect to a vertical direction and a positive signal with respect to a horizontal direction.

It is also conceivable that a maintenance process is initiated instead of or in addition to a negative signal. The maintenance process may include an examination and/or repair of the structural element 10 and in particular of the through-opening 12.

It is also conceivable that the cloud-based computer system 44 and/or the user computer system 46 comprise at least one documentation store. Then, positive and/or negative signals as well as, optionally, further data, in particular data relating to the structural element 10 and/or the through-opening 12, can be stored in the documentation store.

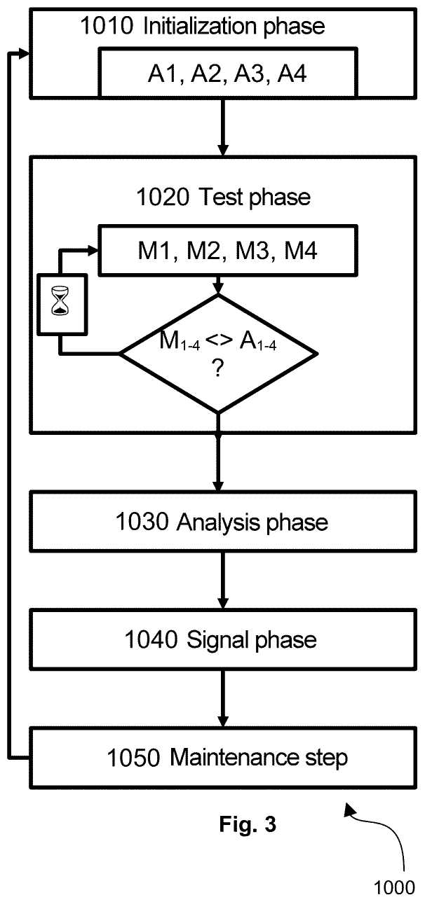

FIG. 3 shows a method 1000 for monitoring a structural element 10.

For the following description of method 1000, reference is made to the reference signs introduced above for the respective elements of the structural element 10 or of the sensor system 24.

As an example, it is assumed that the through-opening 12 of the structural element 10 is initially filled with filling elements 14, as shown in FIG. 1 and described in the associated description.

It will thus be explained in particular how changes to the through-opening 12, assembly errors or the like, can be identified and, if necessary, rectified.

In an initialization phase 1010, initial measured values A1, A2, A3, A4 of each of the four sensors 22 are recorded. The initial measured values A1, A2, A3, A4 are stored in the memory 38. It is ensured that the through-opening 12 and in particular the filling elements 14 of the initial measured values A1, A2, A3, A4 are in a proper condition at the time the measurement is made.

In a test phase 1020, updated measured values M1, M2, M3 and M4 are read out from each of the four sensors 22 after a defined interval, for example 60 seconds, has elapsed.

The measured values M1, M2, M3, M4 read out are compared with the initial measured values A1, A2, A3, A4 of the respective associated sensors 22. As long as the comparison does not reveal any difference or at least no relevant difference between the initial measured values A1, A2, A3, A4 and the associated measured values M1, M2, M3 and M4, the test phase 1020 is repeated at the beginning of the next interval so that new measurements of the measured values M1, M2, M3 and M4 are acquired again and compared with the initial measured values A1, A2, A3, A4, and so on.

During the waiting periods between two measurement times, the controller 30 can be placed in a standby state to extend the service life per full charge of the power source 32.

In these waiting periods, the communication module 42 can also be placed in a standby state, for example by interrupting the radio connection to the cloud-based computer system 44 or by reducing the transmission power, the data rate, and/or the amount of data sent.

However, if a relevant difference, such as a difference exceeding a specific threshold value, is detected between at least one of the initial measured values A1, A2, A3, A4 and the associated measured value of the measured values M1, M2, M3 and M4, then in an analysis phase 1030, the detected difference is further evaluated by the microcontroller 34.

The analysis can be carried out in pairs for each two opposite sensors 22. If a pressure difference results from the respective measured values of the analyzed sensors 22 in each case, this is evaluated as a compressive force in a direction corresponding to the position of the sensors 22 examined. If pressure differences result for multiple pairs of opposite sensors 22, this can be interpreted as a compressive force acting in an inclined direction.

A correlate of the force changes can be derived from the magnitudes of the pressure differences.

Instead of or in addition to absolute pressure differences, it is conceivable that relative pressure differences, in the form of the respective deviations of the measured values M1, M2, M3 or M4 of the sensors 22 examined from their respective initial values A1, A2, A3, A4, are also evaluated. Thus, different loads on the sensors 22 can be taken into account, provided that they occur in a properly functioning state of the through-opening 12.

If at least one compressive force is newly detected, this can be evaluated by the controller 30 as a change to and/or in the through-opening 12.

If at least one such change is detected, in a signal phase 1040 an error signal can be sent to the cloud-based computer system 44 via the communication module 42. The error signal may also contain data on further details of the detected change.

The cloud-based computer system 44 can send a push message to the user computer system 46. This push message can also be used to transmit the data on the identified details of the detected changes.

The user computer system 46 can notify the user of the change.

In a maintenance step 1050, maintenance can then be initiated on the through-opening 12. For example, the through-opening 12 can be examined and, if necessary, properly sealed again with filling elements 14.

If necessary, the sensor system 24 can then be recalibrated and the examination continued. To do this, the method 1000 can start again at the initialization phase 1010.

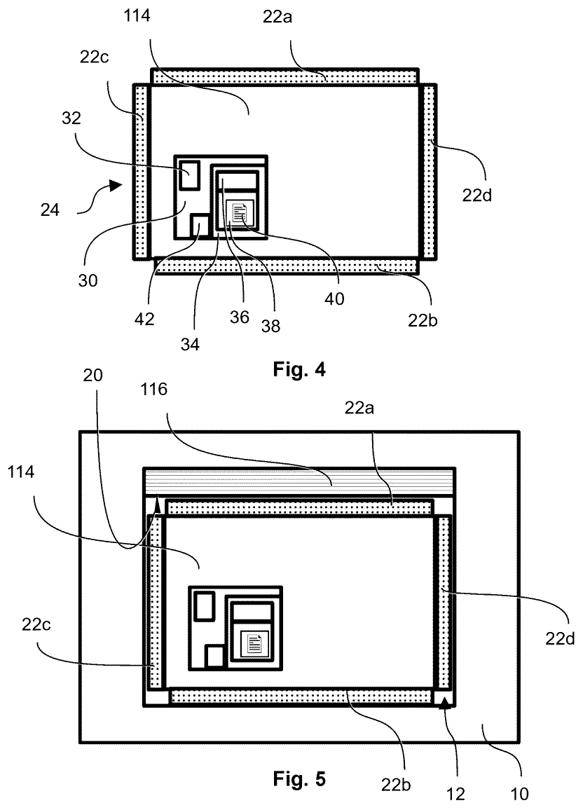

FIG. 4 shows a filling element 114. The filling element 114 is a fire-resistant brick. Accordingly, it is formed at least largely from a fire-retardant material.

It has sensors 22a, 22b, 22c and 22d arranged along a perimeter. The sensors 22a, 22b, 22c and 22d can correspond to the sensors described above in terms of their properties. In particular, these can again be pressure sensors.

A controller 30 is arranged inside the filling element 114. The controller 30 can be located in particular completely inside the filling element 114. In an alternative design, access may be provided to the controller 30, in particular from a direction perpendicular to the image plane according to FIG. 4, so that maintenance works or the like on the controller 30 remain easily possible even with the filling element 114 installed.

The controller 30 and its components are designed in analogous manner to the controller 30 designed in connection with the above-described FIGS. 1 to 3. In particular, the controller 30 again has a power source 32, a microcontroller 34 with a processor 36, a memory 38, and program code 40, as well as a communication module 42.

The controller 30 is electrically connected to the sensors 22a, 22b, 22c and 22d, so that the sensors 22a, 22b, 22c and 22d can be supplied with power and the controller 30 can process the measured values of the sensors 22a, 22b, 22c and 22d in a manner analogous to that described above. Thus, a sensor system 24 is again formed.

The filling element 114 can thus be used autonomously. This makes it particularly suitable for retrofitting structural elements with through-openings.

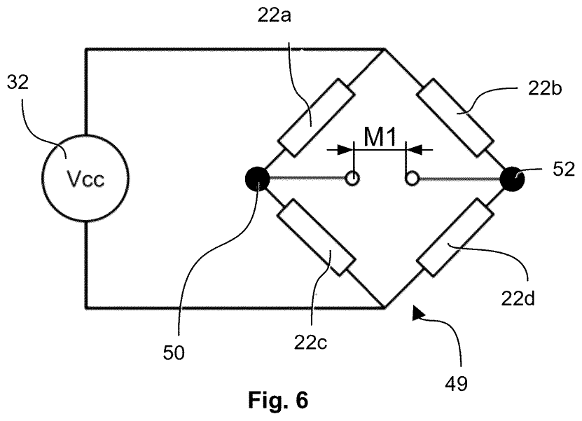

As shown in FIG. 5, the filling element 114 can thus be inserted into a through-opening 12 of a structural element 10.

In the example shown in FIG. 5, the through-opening 12 is formed by the structural element 10 and a cable channel 116 protruding through the structural element 10. Thus, the through-opening 12 is sealed by the filling element 116, in particular for fireproofing.

Thus, the structural element 10 and the cable channel 116 in turn form a structural element with the through-opening 12, thus configuring a sensor system for monitoring the through-opening 12, wherein the sensor system has the four sensors 22a, 22b, 22c and 22d for detecting a measured value of the through-opening 12, the sensors 22a, 22b, 22c and 22d being arranged on an inner circumference 20 of the through-opening 12.

In this respect, by inserting the filler element 114, a structural element with a through-opening can be easily equipped with a monitoring function, even retrospectively. At the same time, the through-opening can be equipped with fireproofing or a fire-retardant function.

FIG. 6 shows a schematic representation of a circuit diagram with four sensors 22a, 22b, 22c and 22d interconnected in a Wheatstone bridge 49, which are supplied with power from the power source 32. This type of interconnection can be realized in the structural elements 10, the sensor system 24 or the filling element 114 described above.

Two of the sensors 22a, 22b, 22c and 22d are connected to each other in series and in parallel with the other two sensors 22a, 22b, 22c and 22d. As the measured value M1, the differential voltage between two center tapping points 50, 52 is measured. The center tapping points 50, 52 correspond in each case to the common connection points of the respective pairs of the sensors 22a, 22b, 22c and 22d connected in series

The influence of drift effects, for example thermally induced drift effects, on the measured value M1 can thus be reduced.

### LIST OF REFERENCE CHARACTERS

10 Structural element
12 Through-opening
14 Filling element
16, 18 Conduit
20 Inner perimeter
22, 22a, 22b, 22c, 22d Sensor
24 Sensor system
26 Connecting lead
28 Connecting cable
30 Controller
32 Power source
34 Microcontroller
36 Processor
38 Memory
40 Program code
42 Communication module
44 Cloud-based computer system
46 User computer system
48 Display
49 Wheatstone bridge
50, 52 Center tapping points
1000 Method
1010 Initialization phase
1020 Test phase
1030 Analysis phase
1040 Signal phase
1050 Maintenance step
A1, A2, A3, A4 Initial measured value
F Compressive force
M1, M2, M3, M4 Measured value

1.-17. (canceled)

18. A structural element (10) having a through-opening (12), comprising:
a sensor system (24) for monitoring the through-opening (12);
wherein the sensor system (24) comprises at least one sensor (22, 22a, 22b, 22c, 22d) for detecting a measured value (M1, M2, M3, M4) of the through-opening (12);
wherein the at least one sensor (22, 22a, 22b, 22c, 22d) is disposed on an inner perimeter (20) of the through-opening (12).

19. The structural element (10) as claimed in claim 18, wherein the at least one sensor (22, 22a, 22b, 22c, 22d) extends over at least two opposite regions of the through-opening (12).

20. The structural element (10) as claimed in claim 18, wherein the through-opening (12) is filled with at least one filling element (14).

21. The structural element (10) as claimed in claim 18, wherein the at least one filling element (14) comprises an elastic material.

22. The structural element (10) as claimed in claim 18, wherein the at least one filling element (14) is fire-retardant or sound-insulating or fluid-sealing.

23. A sensor system (24) for arrangement on a structural element (10) having a through-opening (12), comprising:
at least one sensor (22, 22a, 22b, 22c, 22d) which is arrangeable on an inner perimeter (20) of the through-opening (12) of the structural element (10);
wherein a measured value (M1, M2, M3, M4) of the through-opening (12) is detectable by the at least one sensor (22, 22a, 22b, 22c, 22d).

24. The sensor system (24) as claimed in claim 23, wherein the at least one sensor (22, 22a, 22b, 22c, 22d) is a pressure sensor or a voltage sensor or a strain sensor or a force sensor.

25. The sensor system (24) as claimed in claim 23, wherein the at least one sensor (22, 22a, 22b, 22c, 22d) has an elongated shape.

26. The sensor system (24) as claimed in claim 23, wherein the at least one sensor (22, 22a, 22b, 22c, 22d) comprises a layer structure, wherein one layer of the layer structure is an adhesive layer or a friction-enhancing layer.

27. The sensor system (24) as claimed in claim 23, wherein the at least one sensor (22, 22a, 22b, 22c, 22d) has at least one optical fiber.

28. The sensor system (24) as claimed in claim 23, wherein the at least one sensor (22, 22a, 22b, 22c, 22d) comprises at least two sensors.

29. The sensor system (24) as claimed in claim 23, wherein the at least one sensor (22, 22a, 22b, 22c, 22d) comprises at least four sensors arranged in a Wheatstone bridge (49).

30. The sensor system (24) as claimed in claim 23, further comprising a controller (30) and/or an energy source (32).

31. A filling element (114), wherein the filling element (114) is a fire-resistant brick or comprises a fire resistant brick, comprising:
a sensor system (24), wherein the sensor system (24) comprises at least one sensor (22, 22a, 22b, 22c, 22d) and wherein the at least one sensor (22, 22a, 22b, 22c, 22d) is disposed on a perimeter of the filling element (114).

32. The filling element (114) as claimed in claim 31, wherein the filling element (114) is elastically deformable.

33. A method (1000) for monitoring a structural element (10), comprising the step of:
measuring at least one measured value (M1, M2, M3, M4) of a through-opening (12) of the structural element (10) by at least one sensor (22, 22a, 22b, 22c, 22d) disposed on an inner perimeter (20) of the through-opening (12).

34. The method (1000) according to claim 33, wherein the measuring comprises measuring two measured values (M1, M2, M3, M4) at at least two opposite regions of the inner perimeter (20) of the through-opening (12).
